(19) United States
(12) Patent Application Publication
(10) Pub. No.: US 2014/0016808 A1
(43) Pub. Date: Jan. 16, 2014

(54) USER ADJUSTABLE OPEN-FIT TUBING SYSTEM FOR A HEARING AID AND METHOD FOR ITS USE

(71) Applicants: Sreekant Cherukuri, Chicago, IL (US); Sreenivas Cherukuri, Novi, MI (US)

(72) Inventors: Sreekant Cherukuri, Chicago, IL (US); Sreenivas Cherukuri, Novi, MI (US)

(21) Appl. No.: 13/549,044

(22) Filed: Jul. 13, 2012

(51) Int. Cl. H04R 25/00

(52) U.S. Cl. 381/324; 29/594

(57) ABSTRACT

An adjustable open-fit thin tubing system for a hearing aid is provided comprising a generally straight flexible thermoplastic tube, a connector tube molded to one end of the generally straight tube, and a connector plug having a hollow bore molded to the opposite end of the connector tube, wherein the generally straight tube is adapted to be fitted at a distal end to the hearing aid, and wherein the connector plug includes an eartip at a proximal end adapted to be inserted into a human ear. The connector tube may be sound conducting thin flexible tubing manufactured from a heat-treated thermoplastic material, and may describe a single curve toward the ear canal having a radius r. The present hearing aid thin tubing system is modular, open-fit and adapted to fit behind the ear (BTE) hearing aid devices, and is adapted to be aligned and adjusted by the individual user.

### FIELD OF THE INVENTION

Open-fit hearing aids can be configured as low-form, thin tubing devices which are convenient for the user and self-adjustable. The present hearing aid thin tubing system is modular, open-fit and can be adapted to fit behind the ear (BTE) hearing aid devices and can accommodate various in the ear domes.

### BACKGROUND

Hearing aids are well established as useful medical devices throughout the world. Innovations in this field have kept pace with medical technology, microcircuitry, and digital devices. At the present time, a wide range of options exist for the hearing impaired individual.

“Open-fit” or over-the ear (OTE) hearing aids include small behind-the-ear (BTE) type devices. This type is characterized by a minimal amount of effect on the ear canal resonances, as it traditionally leaves the ear canal as open as possible, often only being plugged up by a small speaker resting in the middle of the ear canal space. Alternatively, these hearing aids have a small plastic case behind the ear and a small clear tube running into the ear canal. Inside the ear canal, a small soft silicone dome or a molded, highly vented acrylic tip holds the tube in place. This design is intended to reduce the occlusion effect. The occlusion effect occurs when an object fills the outer portion of a person's ear canal, and that person perceives “hollow” or “booming” echo-like sounds of their own voice. It is caused by bone-conducted sound vibrations reverberating off the object filling the ear canal.

Untreated hearing loss is a serious problem, and may result in depression, social isolation, and anxiety in an individual. An open-fit tubing system can be particularly effective in a patient having mild to severe high frequency losses, when coupled with an appropriate hearing aid for transmitting sound. However, most commercially-available open-fit tubing is provided in a range of custom sizes and must be fitted by a certified audiologist or physician.

Therefore, the main disadvantage of current technology is that it requires the user to be measured and fit in the presence of a hearing aid professional. Depending on what part of the country (or part of the world) the user is in, there may not be a professional in the nearby vicinity. Currently, the only way to minimize this disadvantage is for the user to purchase several sizes of tubing lengths and choose based on trial-and-error, which is not an economical solution.

If a way could be found to provide an economical and versatile, user-adjustable modular tubing system adapted for connection to a suitable hearing aid device, this would represent a useful contribution to the art.

Further, if a method were provided for self-adjusting open-fit hearing aid tubing by simply cutting a portion of the tubing in order to fit said tubing to the correct size for an individual user, this would represent a useful contribution to the art. Such a method would enable a hearing impaired patient to custom fit and install an economical hearing aid on his or her own, without a doctor's visit, thus saving further medical expenses.

### SUMMARY

In one embodiment, an adjustable open-fit thin tubing system is provided comprising a generally straight flexible thermoplastic tube, a connector tube molded to one end of the generally straight flexible thermoplastic tube, and a connector plug having a hollow bore molded to the opposite end of the connector tube, wherein the generally straight flexible tube is adapted to be fitted at a distal end to a hearing aid device, and wherein the connector plug includes an eartip at a proximal end adapted to be inserted into a human ear. The connector tube may be sound conducting thin flexible tubing manufactured from a heat-treated thermoplastic material, and may describe a single curve toward the ear canal having a radius r.

In one alternative embodiment, the tubing system comprises a connector plug further including a pliable stabilizer bar extending outwardly from the surface of the connector plug and which is unitary with the connector plug, and having a length from about 3.0 cm to about 4.0 cm.

In another embodiment, there is provided a method for self-adjustment and fitting of a tubing system for a hearing aid by an individual user for an ear of the user, comprising the steps of:

(a) providing a tubing system for a hearing aid comprising: a generally straight flexible thermoplastic tube adapted for cutting by the user, a connector tube molded to one end of the generally straight flexible thermoplastic tube, and a connector plug having a first hollow bore molded to the opposite end of the connector tube, wherein the generally straight flexible tube is adapted to be fitted at a distal end to a hearing aid device, and wherein the connector plug includes an eartip at a proximal end adapted to be inserted into a human ear, the connector plug optionally including a pliable stabilizer bar extending outwardly from the surface of the connector plug and which is unitary with the connector plug, and having a length from about 3.0 cm to about 4.0 cm;

(b) installing a behind-the-ear (BTE) hearing aid including an ear hook having a second hollow bore for transmission of sound by hanging the ear hook over the top of and behind the ear of the user wherein the ear hook is in a substantially face-forward direction;

(c) inserting the eartip into the ear canal of the user, wherein the eartip alternatively includes one or more annular ribs whereby an elastomeric open-fit dome is frictionally fitted to the eartip;

(d) aligning the generally straight flexible thermoplastic tube adjacent to the ear hook in such a manner that the generally straight flexible thermoplastic tube remains generally straight;

(e) cutting the aligned generally straight flexible thermoplastic tube to provide a cut tubing having a cut tubing length for connecting to the ear hook;

(f) attaching the cut tubing of the generally straight flexible thermoplastic tube to the ear hook to provide the tubing system for the hearing aid that is self-adjusted and fitted to the individual user; and

(g) optionally cutting the pliable stabilizer bar, and

(h) optionally fitting the pliable stabilizer bar within the ear of the user in such a manner that the eartip is tensioned toward and held within the ear canal of the user.

The connector tube used in the method may be manufactured from a sound conducting thin flexible tubing manufactured from a heat-treated thermoplastic material, and may describe a single curve toward the ear canal having a radius r.

### BRIEF DESCRIPTION OF THE DRAWINGS

These and other features, aspects, and advantages of the presently claimed invention will become better understood with regard to the following description, appended claims, and accompanying drawings where:

FIG. 1 illustrates an exploded perspective view of one embodiment of a user-adjustable, open-fit, modular thin tubing system for a hearing aid for a user's right ear, including a silicone dome that is presented for illustrative purposes.

FIG. 2 illustrates an elevation view of one embodiment of the modular thin tubing system of FIG. 1 for a user's right ear.

FIG. 3 illustrates an elevation cross-sectional view of modular thin tubing system of FIG. 2.

FIG. 4 illustrates the left side view of one embodiment of the modular thin tubing system of FIG. 2 for a user's right ear.

FIG. 5 illustrates the right side (proximal) view of one embodiment of the modular thin tubing system of FIG. 2 for a user's right ear.

FIG. 6 illustrates the top (distal) view of one embodiment of the modular thin tubing system of FIG. 2 for a user's right ear.

FIG. 7 illustrates a view of another embodiment of a user-adjustable, open-fit, modular thin tubing system fitted to a user's right ear, including a silicone dome inserted into the ear canal of the user that is presented in dashed line for illustrative purposes, and including a hearing aid device that is presented in dashed line for illustrative purposes.

FIG. 8A illustrates one embodiment of a method for self-adjusting and fitting of a modular thin tubing system for a hearing aid by an individual user for the user's left ear, by installing a behind-the-ear (BTE) hearing aid device using an ear hook.

FIG. 8B illustrates one embodiment of a method for self-adjusting and fitting of a modular thin tubing system for a hearing aid by an individual user for the user's left ear, by providing a modular thin tubing system having a generally straight flexible tube adapted for cutting at a distal end for a user's left ear, and including a silicone dome installed on an eartip at a proximal end and by inserting the dome into the ear canal, in such a manner that the uncut generally straight flexible tube remains generally straight and extends beyond the ear hook of the hearing aid device.

FIG. 8C illustrates one embodiment of a method for self-adjusting and fitting of a modular thin tubing system for a hearing aid by an individual user for the user's left ear, by aligning the generally straight flexible thermoplastic tube in such a manner that the uncut generally straight flexible tube remains generally straight and remains immediately adjacent to and extends beyond the ear hook of the hearing aid device in order to determine an appropriate cut tubing length for connecting to the ear hook of the hearing aid device. The upper and lower horizontal dashed lines indicate guides for subsequent cutting adjustment of the flexible thermoplastic tube.

FIG. 8D illustrates one embodiment of a method for self-adjusting and fitting of a modular thin tubing system for a hearing aid by an individual user for the user's left ear, by cutting the aligned generally straight flexible thermoplastic tube to provide an appropriate cut tubing having a tubing length for connecting to the ear hook of the hearing aid device.

FIG. 8E illustrates one embodiment of a method for self-adjusting and fitting of a modular thin tubing system for a hearing aid by an individual user for the user's left ear, illustrating the cut and aligned generally straight flexible thermoplastic tube providing an appropriate cut tubing length for connecting to the ear hook of the hearing aid device.

FIG. 8F illustrates one embodiment of a method for self-adjusting and fitting of a modular thin tubing system for a hearing aid by an individual user for the user's left ear, by attachment of the cut tubing, that is, by attaching the cut tubing of the generally straight flexible thermoplastic tube to the ear hook to provide the tubing system for the hearing aid that is self-adjusted and fitted to the left ear of the individual user.

FIG. 8G illustrates one alternative embodiment of a method for self-adjusting and fitting of a modular thin tubing system for a hearing aid by an individual user for the user's left ear, by attachment of the cut tubing, that is, by attaching the cut tubing of the generally straight flexible thermoplastic tube to the ear hook, and by fitting a pliable stabilizer bar within the ear of the user in such a manner that the eartip with dome is tensioned toward and held within the ear canal of the user to provide the tubing system for the hearing aid that is self-adjusted and fitted to the left ear of the individual user.

### DETAILED DESCRIPTION

The following description and examples further illustrate the invention but, of course, should not be construed as in any way limiting its scope. Herein is described an adjustable tubing system for a hearing aid.

In one embodiment, the elements may include but are not limited to the following components. Certain elements may be optional components, as described below.

| | |
|---|---|
| Adjustable Tubing System | 10 |
| Generally straight flexible thermoplastic tube | 20 |
| Tubing lumen | 22 |
| Cut tubing | 24 |
| Tapered collar | 25 |
| Connector tube | 30 |
| Connector tube lumen | 32 |
| Radius of connector tube | r |
| Connector plug | 40 |
| Sleeve | 42 |
| Retaining collar | 44 |
| Eartip | 50 |
| Annular rib(s) | 52 |
| Stabilizer bar | 60 |
| Orthogonal connection point | 65 |
| Sound passageway | 70 |
| Bore opening of Connector plug | 75 |
| Distal end | D |
| Proximal end | P |
| Cut tubing length | L |
| User | 200 |
| User's ear | 210 |
| Ear canal | 220 |
| Hearing aid device | 300 |
| Ear hook | 305 |
| Bore opening of Ear hook | 310 |
| Dome | 400 |
| Upper dashed cutting line | 501 |
| Lower dashed cutting line | 502 |

Suitable hearing aid devices include behind-the-ear (BTE) low form type that are designed to be used with earhooks compatible with size 13 (ID 0.076″) tubing. One exemplary hearing aid device, which includes an ear hook, is the MDHearingAid PRO® hearing aid available from SC Industries (Chicago, Ill.).

Domes are used for insertion into the user's ear canal, after appropriate sizing and fitting to a hearing aid device. Commercially available domes may be closed or open fit, or may be an eartip/earbud or mushroom type, and may be made from, for example, a soft malleable silicone or acrylic material. Domes are intended to be frictionally fit into a user's ear canal and so be held in and reside for comfortable long-term and daily use. Some domes are manufactured in such a manner to be frictionally fitted to a tubing system (i.e. using a hollow center cutout for passage of sound), and to concomitantly be frictionally fitted to a user's ear using the “outer” domed surface or top surface.

Domes may be provided having many different shapes and sizes. Standard diameters for the closed-fit domes include 9 mm, 12 mm, and 15 mm, and open-fit domes include 6 mm, 9 mm, and 12 mm. Useful open-fit and closed-fit domes may be obtained from SC Industries (Chicago, Ill.).

Therefore in accordance with one aspect, a user-adjustable, open-fit, modular thin tubing system is described having a generally straight flexible thermoplastic tube, a connector tube molded to one end of the generally straight flexible thermoplastic tube, and a connector plug having a hollow bore molded to the opposite end of the connector tube. The components of the tubing system individually possess a continuous tube or passage, and when assembled together provide a passageway for air and sound waves transmitted through the air. Thin tubing is known to possess outstanding qualities for efficient and hi-fidelity transmission of sound waves. In the present invention, the optimal tubing types, materials, and sizes are selected for use, aesthetics, technical performance, convenience, and operability.

Further, the user-adjustable, open-fit, modular thin tubing system includes a generally straight flexible tube adapted to be fitted at a distal end to a hearing aid device, and a connector plug including an eartip at a proximal end adapted to be inserted into a human ear.

It is to be understood that the tubing system as described herein may be applied to either one or both ears of an individual user. Any components or operations are understood to have a mirror image or may be employed or practiced using mirror image operations. Therefore, this invention is usefully and practically applied to either the right ear or the left ear, or both ears.

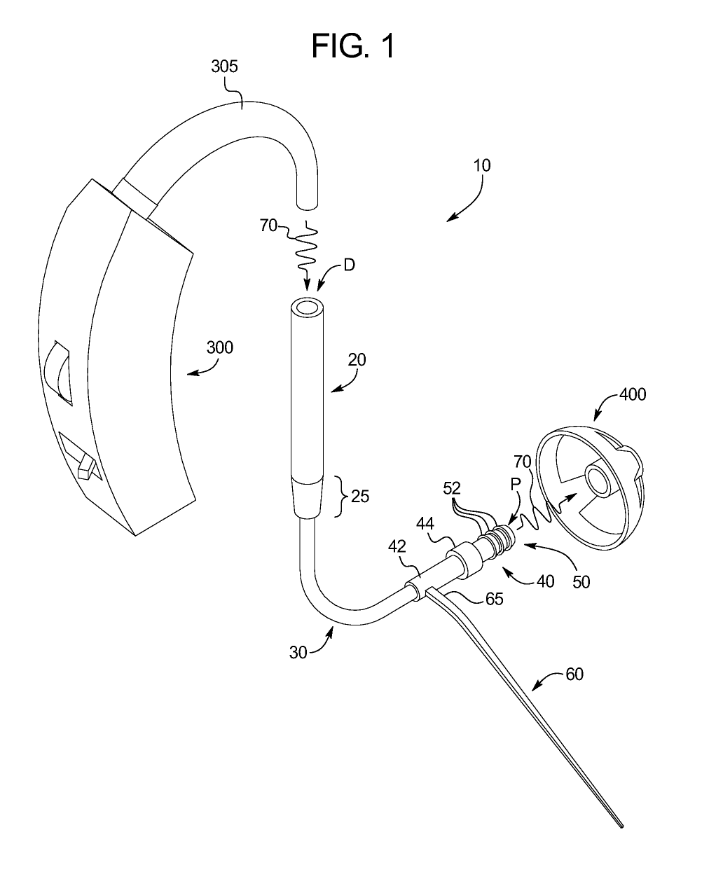

Referring now to the drawings, the user-adjustable, open-fit, modular thin tubing system is shown and generally indicated as apparatus 10. Referring to FIG. 1, there is provided, according to one embodiment of the present invention, an adjustable tubing system 10 which is intended to be fitted to a user's right ear. The adjustable tubing system 10 has a distal end D which may be connected to a hearing aid device (300), and a proximal end P which may optionally be fitted with a dome (400). The proximal end P may be inserted into a human ear of the user, preferably in close proximity of, or within, a user's ear canal.

Adjustable tubing system 10 includes a generally straight flexible thermoplastic tube 20, and a connector tube 30 having two ends, one end of the connector tube 30 being molded on to one end of the generally straight flexible thermoplastic tube 20, and the opposite end of the connector tube 30 being molded on to a connector plug 40. The generally straight flexible thermoplastic tube 20 may be oriented generally upward toward the top of the ear and in the direction of the top of the head of the user. The generally straight flexible thermoplastic tube 20 may be attached to the connector tube 30 using a tapered collar 25 or other sleeve as appropriate, in order to provide a continuous passageway for air and sound to travel through the generally straight flexible thermoplastic tube 20, and the connector tube 30. The connector plug 40 at its terminal or proximal end includes an eartip 50. In one optional embodiment, the eartip 50 includes one or more annular ribs 52. The connector plug may include an exterior annular retaining collar 44, for the purpose of retaining a dome 400 with a precise fit to the eartip 50. Further, the connector plug 40 may be attached to the connector tube 30 at its opposite end using a sleeve 42 or other sleeve as appropriate, in order to provide a continuous passageway for air and sound to travel through the connector plug 40, and the connector tube 30.

It should be noted that the individual components, whether joined or separate, each contain a generally tubular or cylindrical passageway to allow for the efficient and free passage of sound waves. In its principal embodiment, the adjustable tubing system 10 includes a sound passageway 70 that is continuous, extending from distal end D through proximal end P, that is the passageway connecting the hearing aid device at D running through to the eartip 50 at P which allows for efficient transmission of sound. Under optimal conditions, sound or sounds are unoccluded. In a preferred embodiment of the adjustable tubing system 10, the occlusion effect is minimized.

Optionally, the connector plug 40 includes a pliable and flexible stabilizer bar 60 extending outwardly and generally orthogonal to the cylindrical surface of the sleeve 42 at a connection point 65. The flexible stabilizer bar 60 may be unitary with the connector plug 40. In one embodiment, the connector plug 40 comprises the eartip 50 including one or more annular ribs 52, and the exterior annular retaining collar 44 as one molded piece. In an alternative embodiment, the connector plug 40 comprises the eartip 50 including one or more annular ribs 52, the exterior annular retaining collar 44, and the flexible stabilizer bar 60 extending outwardly and generally orthogonal to the cylindrical surface of the sleeve 42, as one molded piece.

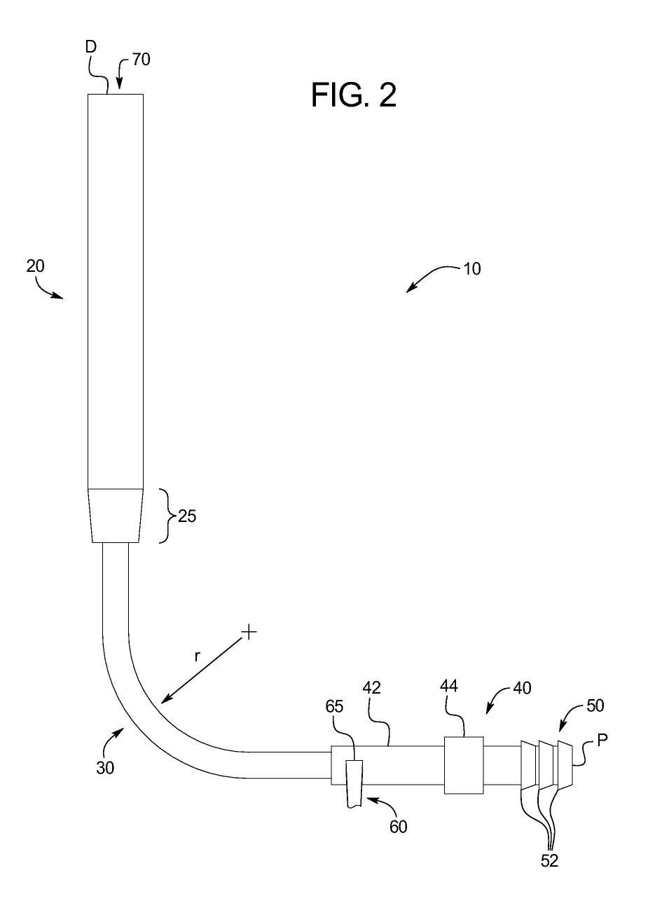

With reference to FIG. 2, an elevational view is depicted of an embodiment of the user-adjustable, open-fit, modular thin tubing system 10 adapted for a user's right ear. As seen in FIG. 1, the generally straight flexible thermoplastic tube 20 is affixed to a connector tube 30 having two ends, one end of the connector tube 30 being molded on to or molded around one end of the generally straight flexible thermoplastic tube 20, and the opposite end of the connector tube 30 being molded on to or molded around a connector plug 40. The generally straight flexible thermoplastic tube 20 may be attached or molded to the connector tube 30 using a tapered collar 25 or other shaped sleeve as appropriate, in order to provide a continuous passageway for air and sound to travel through the generally straight flexible thermoplastic tube 20, and the connector tube 30. The connector plug 40 at its terminal or proximal end includes an eartip 50.

The connector tube 30 functions as a sound tube and comprises sound tubing made of a thermoplastic material such as thermoplastic elastomer or thermoplastic rubber. The connector tube 30 may be heat treated in order to provide a curvature or radius. In its principal embodiment, the connector tube includes a radius r. In other embodiments, the connector tube may include one or more curves, or alternatively may include parabolic curves, curve functions, or other 3-dimensional curved configurations. The curved connector tube 30 provides an overall angling seen from the distal end D to the proximal end P of approximately 90°, although the angle can range from about 80° to about 100°. When in use, the effective angle or curvature may vary even more substantially, depending on the size and shape of the individual user's ear.

The connector plug 40 in FIG. 2 includes an eartip 50 having one or more annular ribs 52. The connector plug also includes an exterior annular retaining collar 44, for the purpose of retaining a dome 400 (not shown) with a precise frictional fit to the eartip 50. Further, the connector plug 40 is attached by molding to the connector tube 30 at its opposite end using a sleeve 42 or other sleeve as appropriate, in order to provide a continuous passageway for air and sound to travel through the connector plug 40 via a bore (not shown), and the connector tube 30. Further, the connector plug 40 has a pliable and flexible stabilizer bar 60 molded in such fashion that it extends outwardly and generally orthogonal to the cylindrical surface of the sleeve 42 at a connection point 65. The flexible stabilizer bar 60 may be unitary with the connector plug 40. In one embodiment, the connector plug 40 comprises the eartip 50 including one or more annular ribs 52, and the exterior annular retaining collar 44 as one molded piece. In an alternative embodiment, the connector plug 40 comprises the eartip 50 including one or more annular ribs 52, the exterior annular retaining collar 44, and the flexible stabilizer bar 60 extending outwardly and generally orthogonal to the cylindrical surface of the sleeve 42, as one molded piece. It is noted that in FIGS. 2 and 4-6 the stabilizer bar 60 is truncated for illustrative purposes.

The entire modular system comprising the adjustable tubing system 10 defines and includes one continuous open tubular airway or open cylindrical passageway for sound or sound waves 70 extending from distal end D through proximal end P.

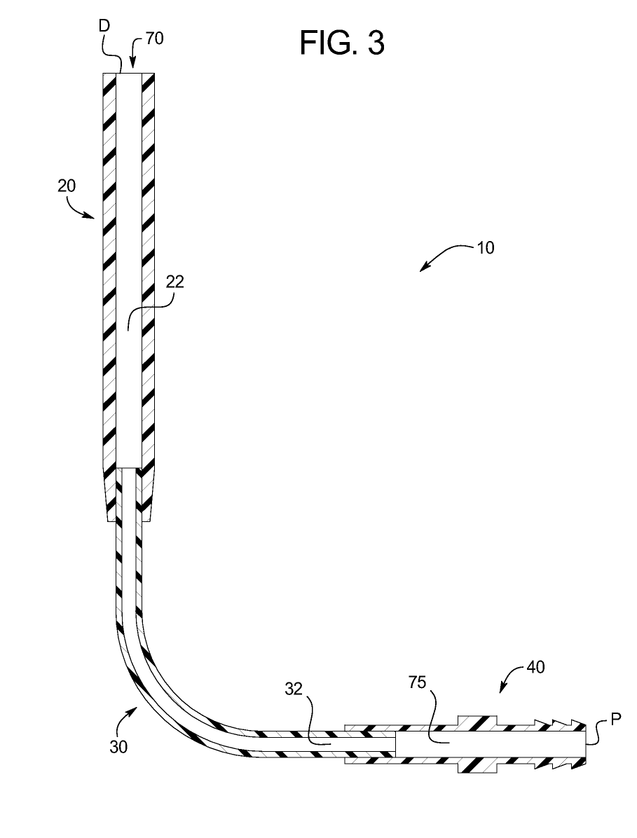

FIG. 3 shows an elevational cross-sectional view of the user-adjustable, open-fit, modular thin tubing system 10 of FIG. 2. Beginning at distal end D, a tubing lumen 22 is defined by the interior space of the generally straight flexible thermoplastic tube 20, opening into a connector tube lumen 32 defined by the interior space of the connector tube 30, and exiting from a bore opening 75 of connector plug 40 at proximal end P. Together, the interior spaces as described provide an open passageway for sound 70. This figure demonstrates that each of the different components possess a hollow bore of varying internal diameters, together defining a single continuous pathway, and are so sized and manufactured to efficiently conduct sound waves. The different types of molded materials are illustrated, demonstrating the versatile modular construction of the apparatus.

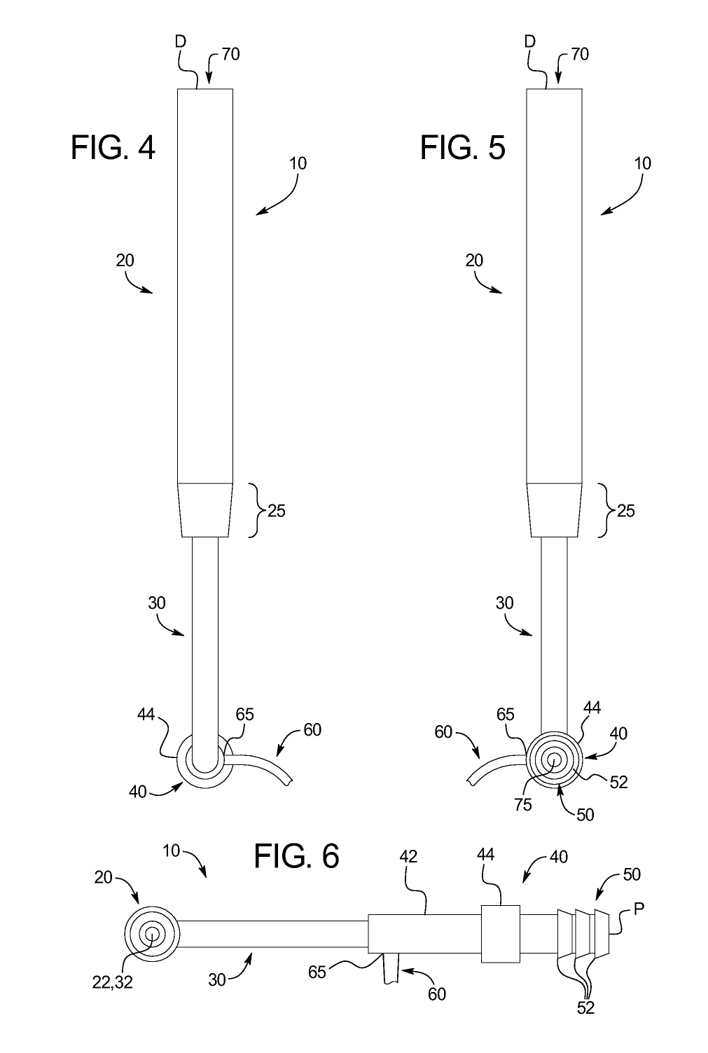

FIG. 4 is a left side elevational view of the user-adjustable, open-fit, modular thin tubing system 10 of FIG. 2 for a user's right ear. The adjustable tubing system 10 includes a generally straight flexible thermoplastic tube 20, and a connector tube 30 having two ends, one end of the connector tube 30 being molded on to or molded around one end of the generally straight flexible thermoplastic tube 20, and the opposite end of the connector tube 30 being molded on or molded around to a connector plug 40. The generally straight flexible thermoplastic tube 20 may be oriented generally upward toward the top of the ear and in the direction of the top of the head of the user. As shown in this embodiment, the connector plug 40 includes a pliable and flexible stabilizer bar 60 extending outwardly and generally orthogonal to the cylindrical surface of said connector plug 40.

FIG. 5 is a right side (proximal) elevational view of the user-adjustable, open-fit, modular thin tubing system 10 of FIG. 2 for a user's right ear. The adjustable tubing system 10 includes a generally straight flexible thermoplastic tube 20, and a connector tube 30 having two ends, one end of the connector tube 30 being molded on to or molded around one end of the generally straight flexible thermoplastic tube 20, and the opposite end of the connector tube 30 being molded on or molded around to a connector plug 40. The generally straight flexible thermoplastic tube 20 may be oriented generally upward toward the top of the ear and in the direction of the top of the head of the user. As shown in this embodiment, the connector plug 40 includes a pliable and flexible stabilizer bar 60 extending outwardly and generally orthogonal to the cylindrical surface of said connector plug 40. The connector plug 40 contains a bore opening 75 exiting from an eartip 50 at a proximal end (P).

FIG. 6 is a top (distal) view of the user-adjustable, open-fit, modular thin tubing system 10 of FIG. 2 for a user's right ear. As shown and viewed directly from the top, the tubing lumen 22 of the generally straight flexible thermoplastic tube 20 can be seen to pass continuously to the connector tube lumen 32 of the connector tube 30. The lumen portions 22, 32 combine with the bore opening 75 of connector plug 40 to form a continuous sound passageway 70. Note that the distal end (D) of the generally straight flexible thermoplastic tube 20 is adjustable and trimmable to a length required by an individual user.

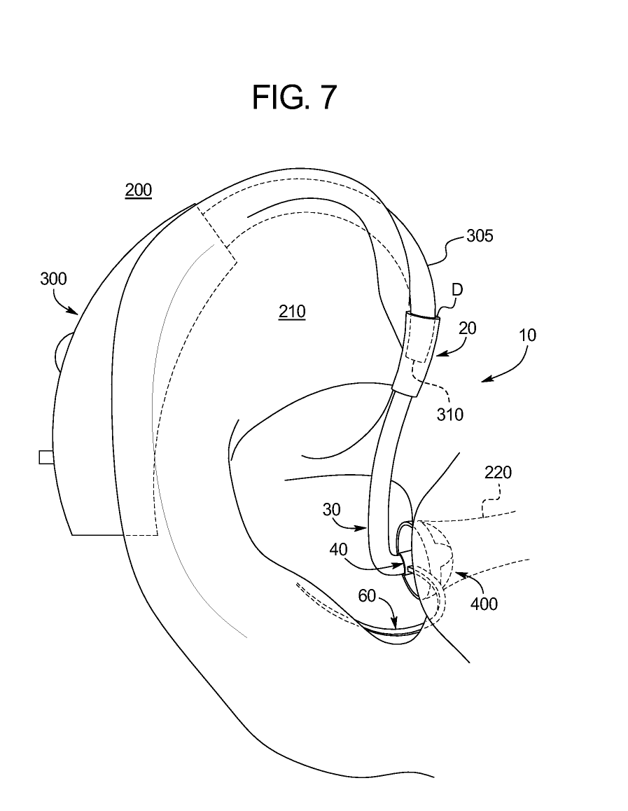

The user-adjustable, open-fit, modular thin tubing system 10 is described in FIG. 7 as sized and adapted to be fit to a human ear of user 200. In this embodiment, the adjustable tubing system is fitted to a user's right ear. A hearing aid device 300 is attached to the adjustable generally straight flexible thermoplastic tube 20 at distal end D by a slidable and frictional connection to an ear hook 305. The adjustable generally straight flexible thermoplastic tube 20 being connected to the connector tube 30, loops down around and along the side of the user's ear 210 and curves into the ear canal 220, and is further connected via the connector plug 40 having eartip 50 to an elastomeric dome 400 inserted into the ear canal 220. Furthermore, the adjustable thin tubing system 10 is optionally stabilized by an adjustable stabilizer bar 60 within the ear of the user in such a manner that the eartip 50 and/or dome 400 and is tensioned toward and held within the ear canal 220 of the user.

The views and descriptions presented herein are for a user's right ear. Consequently, the views and descriptions, were they made for a user's left ear are understood to be substantially or essentially mirror images of FIGS. 1-7 thereof, taking into account differences among individuals with regard to ear size and structure, and even differences within the same individual.

It should be appreciated that components or parts as described herein are optionally separable, hence in its various embodiments the invention is modular in use and practice. Conversely, in other embodiments the components or parts may be joined or unitary. Components may be separate (i.e., modular and joinable), joined, or unitary. For example, the connector plug 40 may be molded as a unitary piece together with a sleeve 42, a retaining collar 44, and a stabilizer bar 60 as described herein.

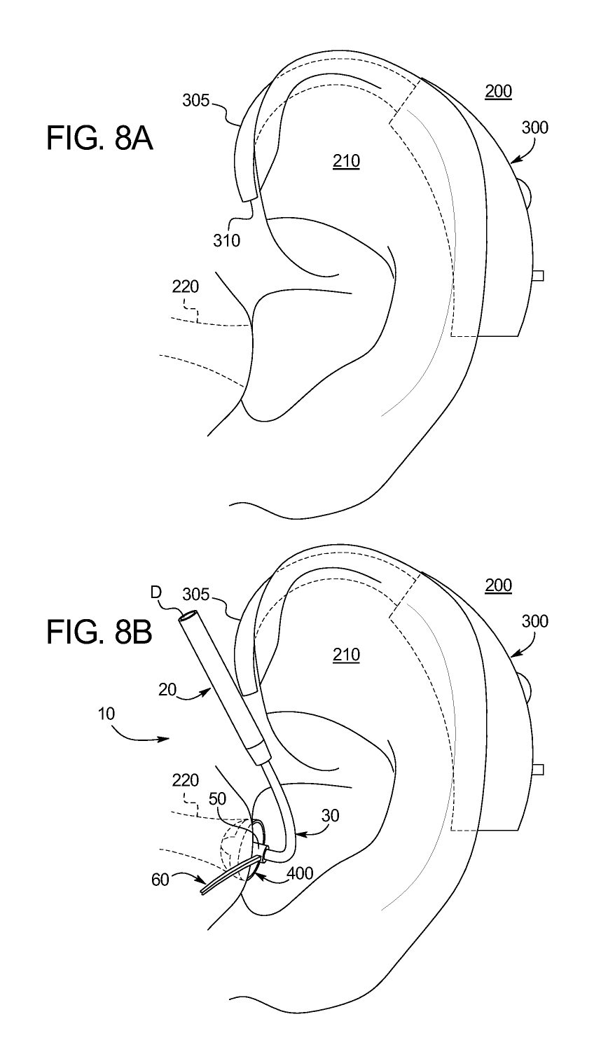

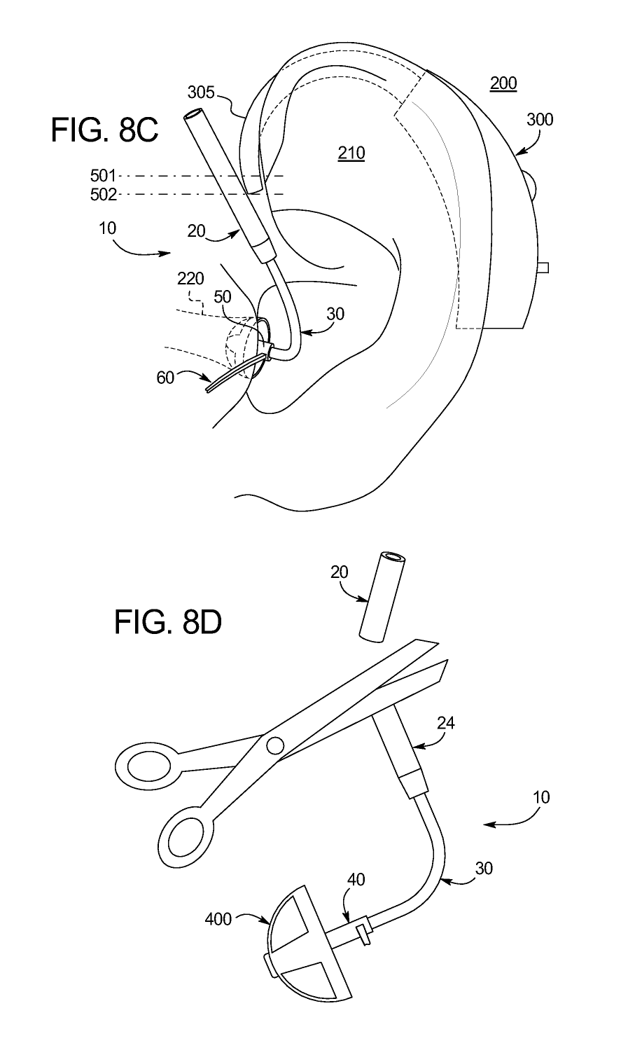

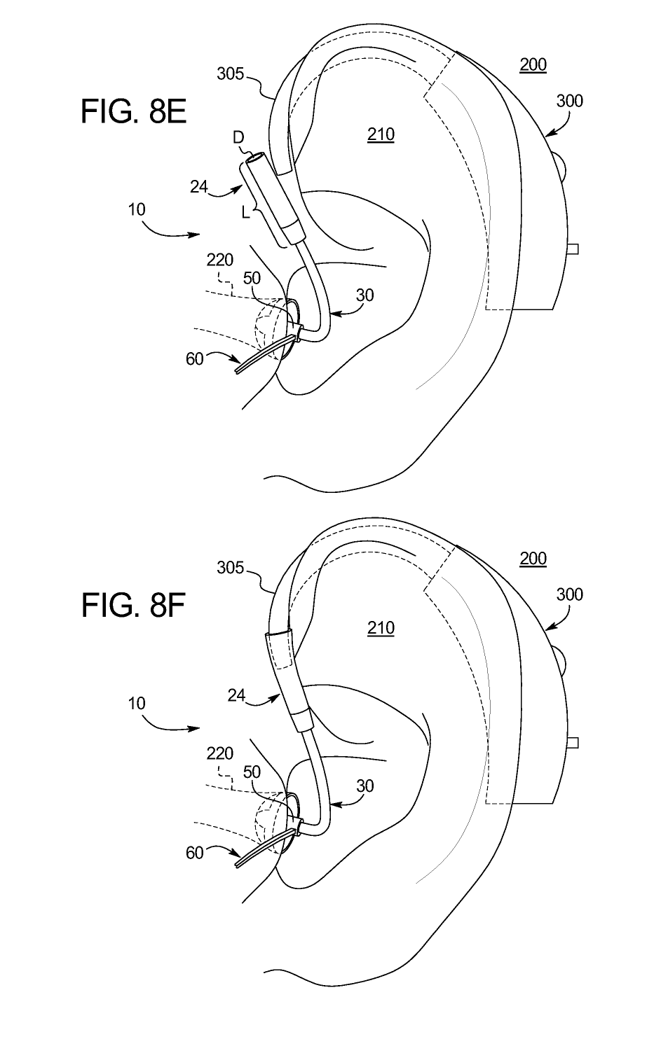

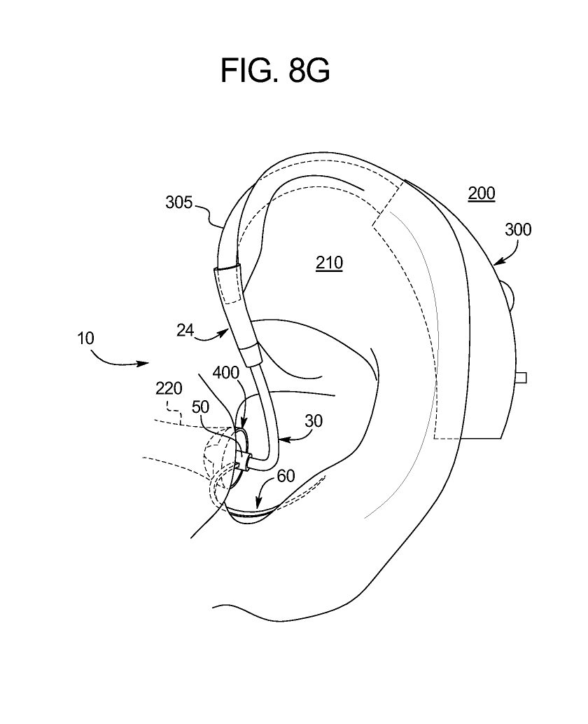

In an embodiment, a method is contemplated for self-adjusting the user-adjustable, open-fit, modular thin tubing system 10 and subsequently or concomitantly fitting the tubing system 10 for a hearing aid by an individual user for at least one ear of the user. Referring to FIG. 8A, the process has been applied to a user's left ear. First, the user 200 obtains and installs a behind-the-ear (BTE) hearing aid device 300 having an ear hook 305 by hanging the ear hook 305 over the top of and behind the user's ear 210. Notably, the ear hook 305 is generally hollow plastic and includes a bore opening 310 (that transmits sound from an internal loudspeaker).

In FIG. 8B, the user provides a modular thin tubing system 10 having an eartip 50 fitted with an elastomeric dome 400 and inserts the dome 400 into the user's ear canal 220 in such a manner that the uncut adjustable generally straight flexible thermoplastic tube 20 remains generally straight and extends beyond the ear hook 305 of the hearing aid device 300 generally upwardly toward the top of the user's head. In this embodiment, the uncut adjustable generally straight flexible thermoplastic tube 20 is adaptable for cutting at a distal end (D).

In FIG. 8C, the user aligns the uncut adjustable generally straight flexible thermoplastic tube 20 in such a manner that the uncut adjustable generally straight flexible thermoplastic tube 20 remains generally straight and remains immediately adjacent to and extends beyond the ear hook 305 of the hearing aid device 300 generally upwardly toward the top of the user's head. The purpose of this alignment step is to determine an appropriate cut tubing length L of tube 20 for connecting to the ear hook 305 of the hearing aid device 300. For example, a first general cutting can be performed using an upper dashed line 501 as a guide for alignment, as shown in FIG. 8C. The upper and lower horizontal dashed lines 501, 502 indicate guides for subsequent cutting adjustment of the flexible thermoplastic tube 20, which dashed lines generally intersect or align with the bore opening of the ear hook 310.

In FIG. 8D, the user cuts the aligned generally straight flexible thermoplastic tube 20 which remains generally straight and remains immediately adjacent to and extends beyond the ear hook 305 of the hearing aid device 300 upwardly toward the top of the user's head, in order to provide a cut tubing 24 having an appropriate cut tubing length L for connecting to the ear hook 305. After the first cutting, it is recommended that any subsequent cut be performed in small increments, on the order of about 1-1.5 mm (ca. 1/16 inch) of tubing length in order to preserve and ultimately arrive at the optimal cut tube (20) length L for best fit for the user. Upper and lower dashed lines 501, 502 generally indicate this approximate 1 mm spacing (as an exemplary guideline). This operation comprises a self-adjustment step. This operation further comprises a self-fitting step of an open-fit, modular thin tubing system 10 as described.

It is noted that the cutting operation is generically indicated with scissors, however any appropriate cutting instrument or blade may be employed. Also, it is to be understood that, in most circumstances, the user will mark or score the tubing in some standard fashion prior to cutting and after alignment, and will remove the tubing from the proximity of the ear before cutting for safety's sake. After cutting of the tube (20) to the appropriate length L, the modular thin tubing system 10 is reinstalled and realigned as described above.

In FIG. 8E, the cut tubing 24 having cut tubing length L (and defining distal end D) is shown whereby the user 200 has aligned the tubing and is capable of self-connecting the tubing in a subsequent connecting operation. The user will subsequently manually attach tubing system 10 to the ear hook 305 of the hearing aid device 300 by covering over the bore opening of the ear hook 310 with the distal end D of cut tubing 24.

In FIG. 8F, the cut tubing 24 having cut tubing length L has been manually attached to the ear hook 305 of the hearing aid device 300 by covering over the bore opening of the ear hook 310 with the distal end D of cut tubing 24. The user has thus achieved self-adjustment, and this operation comprises a self-adjustment step. This operation further comprises a self-fitting step of an open-fit, modular thin tubing system 10 as described.

In an embodiment, the user may disconnect the cut tubing for purposes of re-adjustment, or alternatively, to further cut and/or trim the generally straight flexible thermoplastic tube 20 to achieve a better individual fit. After cutting of the tube (20) to the appropriate length L, the modular thin tubing system 10 is reinstalled using the cut tubing 24 and realigned as described above.

In an alternative embodiment, subsequent to the process described above, FIG. 8G shows placement of an integral stabilizer bar 60 in such a manner that the eartip with dome 400 is tensioned toward and held within the ear canal of the user to provide the tubing system for the hearing aid that is self-adjusted and fitted to the left ear of the individual user. Optionally, the stabilizer bar may be cut and/or trimmed to an appropriate length or configuration to achieve a better individual fit.

As described herein, the adjustment and fitting process may be applied equally to a user's right ear.

The generally straight flexible tubing 20 and the connector tube 30 (sound tube) as used herein may be made from a thermoplastic or elastomeric material. The materials used for each component can be the same or different, but should be chemically compatible if different and susceptible to molding manufacturing processes such as extrusion or injection molding. Useful thermoplastics include thermoplastic elastomer (TPE) and thermoplastic rubber (TPR), and mixtures or blends thereof. These materials are generally a class of copolymers or physical blends of polymers. Generally speaking the flexible tubing material may be any material which can be formed into a preformed shape and exhibits sufficient rigidity to hold the eartip 50 within the ear canal of the user and retains it shape when positioned and fitted to the ear of an individual user. Examples of useful tubing materials include, but are not limited to, PVC (polyvinyl chloride), EPM (ethylene propylene rubber, a copolymer of ethylene and propylene) and EPDM rubber (ethylene propylene diene rubber, a terpolymer of ethylene, propylene and a diene-component), and other polyolefin blends; Epichlorohydrin rubber (ECO); Polyacrylic rubber (ACM, ABR); Silicone rubber (SI, Q, VMQ); Fluorosilicone Rubber (FVMQ); Fluoroelastomers (FKM, and FEPM) such as Viton, Tecnoflon, Fluorel, Aflas, and Dai-El; Perfluoroelastomers (FFKM) such as Tecnoflon PFR, Kalrez, Chemraz, and Perlast; Polyether block amides (PEBA) such as Pebax; Chlorosulfonated polyethylene (CSM) such as Hypalon; Ethylene-vinyl acetate (EVA); styrene block copolymers such as Kraton (SBS); thermoplastic polyurethanes; thermoplastic copolyesters such as Hytrel; thermoplastic copolyamides; FEP Teflon; Nylon; polytetrafluoroethylene (PTFE); and the like. Useful tubing materials can have a durometer hardness (Shore D) ranging from about 50 to about 80.

In terms of certain material properties, the generally straight flexible tubing 20 is fairly flexible, and may be joined, glued, attached, or molded to other components as described herein. The generally straight flexible tubing 20 is malleable enough so that it may be attached to a fitting on a hearing aid device by hand by an individual user, for example tubing 20 may be stretched (and securely sealed) over an ear hook 305 at its bore opening 310. For example, an ear hook 305 may include a barbed tip (optional) over which tubing 20, or alternatively cut tubing 24, may be stretched and attached. The generally straight flexible tubing 20 should be malleable enough such that it is readily susceptible to cutting and/or trimming by hand by an individual user, for example using scissors, a penknife, a razor blade, or other bladed cutting instrument. A useful polymer for the generally straight flexible tubing 20 is food grade flexible PVC.

In terms of certain material properties, the connector tube 30 (sound tube) may be made from the same thermoplastic elastomer (TPE) or thermoplastic rubber (TPR) as flexible tubing 20, and is also generally flexible, but yet having a slightly harder and denser formulation than flexible tubing 20, in order to preserve sound quality. The connector tube 30 functions as a sound tube and comprises sound tubing made of a thermoplastic material which may be heat treated for thermosetting or annealing. Heat treatment of the connector tube 30 may be used to confer a permanent and rigid curvature (r). The connector tube 30 may be heat treated in order to provide a curvature or radius. In its principal embodiment, the connector tube 30 includes a radius r configured in such a manner that the connector tube curves toward the ear canal of the user. A useful polymer for the connector tube 30 (sound tube) is food grade flexible PVC.

In one embodiment, the connector tube 30 is generally straight prior to assembly, attachment, connection, or molding to other components such as the generally straight flexible tubing 20 and/or the connector plug 40. Subsequent to assembly, attachment, connection, or molding, curvature may be introduced to the connector tube 30 by using an appropriate heat treatment or thermal process. Thus in one embodiment, the connector tube 30, the generally straight flexible tubing 20, and the connector plug 40 are joined together by a molding process in a linear fashion. A heat treatment step is then conducted to bend the connector tube 30 so that the assembly tubing system 10 achieves its finished curvature and angle.

In an embodiment, the relative rigidity and curvature (i.e. radius, r) of the connector tube 30 allows said tube to apply a torque or pressure (i.e., tension) to the eartip 50 toward the proximal end (P) of the tubing system 10, in order to maintain the eartip 50 (when fitted with an open fit dome) in a position in which the eartip 50 (with dome) is pressed against an anatomical feature within the ear canal. This ability to apply a torque or pressure to the eartip 50 (with dome) with the connector tube 30 at its proximal end provides a substantial improvement over flexible tubing used in known BTE hearing aids and kits in which an ear mold must fix the end of a tube in the ear, and such a tube provides no retention or support of the hearing aid device.

Additionally, as described herein, the adjustable thin tubing system 10 is optionally stabilized by an adjustable stabilizer bar 60 within the ear of the user in such a manner that the eartip 50 and/or dome 400 and is further tensioned toward and held within the ear canal of the user.

The generally straight flexible tubing 20 can have: an outer diameter of from about 3.0 mm to about 3.2 mm; an inner diameter of from about 2.3 mm to about 2.4 mm; and a wall thickness of from about 0.3 mm to about 0.4 mm. One suitable length of the flexible tubing 20 for the adjustable tubing system 10 is about 4.0 cm. Another suitable length of the flexible tubing 20 for the adjustable tubing system 10 is about 3.0 cm. A suitable length range of the flexible tubing 20 for the adjustable tubing system 10 is from about 1.5 cm to about 3.0 cm. Another suitable length range of the flexible tubing 20 for the adjustable tubing system 10 is from about 2.0 cm to about 2.5 cm. The aforementioned lengths are adjustable and may be readily adjusted by cutting or trimming by an individual user. One useful tubing is size 13 standard.

The connector tube 30 comprises thin tubing that can have: an outer diameter of from about 1.3 mm to about 1.4 mm; an inner diameter of about 0.8 mm; and a wall thickness of about 0.2 mm. Suitably, the connector tube 30 may comprise: an outer diameter of from about 1.0 mm to about 1.5 mm; an inner diameter of from about 0.8 mm to about 1.0 mm; and a wall thickness of from about 0.1 mm to about 0.3 mm. A suitable length range of the connector tube 30 (sound tube) for the adjustable tubing system 10 is from about 2.2 cm to about 2.3 cm. An alternative suitable length range of the connector tube 30 (sound tube) for the adjustable tubing system 10 is from about 2.0 cm to about 2.5 cm.

The connector plug 40 may be made from any suitable molded thermoplastic such as, for example, PVC, nylon, or PTFE. The connector plug may have a length of from about 1.2 cm to about 1.3 cm; and an outer diameter ranging from about 1.5 mm to about 3.0 mm.

As described above, the connector plug 40 may include an integral and pliable or flexible stabilizer bar 60 extending outwardly and generally orthogonal to the cylindrical surface of the sleeve 42 at a connection point 65. The stabilizer bar 60 is preferably long and thin, having a thickness of approx. 1 mm, optionally tapering down to about 0.5 mm, or less, along its length, and having a width of approx. 2 mm, optionally tapering down to about 1 mm along its length. The integral stabilizer bar 60 may suitably have a length from about 3.0 cm to about 4.0 cm. Alternatively, the integral stabilizer bar 60 may suitably have a length from about 2.0 cm to about 5.0 cm. The stabilizer bar 60 should be malleable enough such that it is readily susceptible to cutting and/or trimming by hand by an individual user, for example using scissors, a penknife, a razor blade, or other bladed cutting instrument. Optionally, the stabilizer bar may be cut and/or trimmed to an appropriate length or configuration to achieve a better individual fit after installation in a user's ear 210.

It must be remembered, that the various embodiments described above may include, in addition to the parts of the presently claimed invention, additional shapes, forms, materials, finishes, and parts suitable for use in these embodiments. Furthermore, these embodiments are non-limiting, and therefore variations of these embodiments will become apparent to those of ordinary skill in the art upon reading the description. Accordingly, this invention includes all modifications and equivalents of the subject matter recited in the claims appended hereto as permitted by applicable law.

All references, including publications, patent applications, and patents, cited herein are hereby incorporated by reference to the same extent as if each reference was individually and specifically indicated to be incorporated by reference and was set forth in its entirety herein.

The use of the terms “a,” “an,” “the,” and similar referents in the context of describing the presently claimed invention (especially in the context of the claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, the whole of the foregoing description is to be construed in an illustrative and not in a limiting sense, the scope of the invention being defined solely by the appended claims.

What is claimed is:

1. A tubing system for a hearing aid comprising:
a generally straight flexible thermoplastic tube,
a connector tube molded to one end of the generally straight flexible thermoplastic tube, and
a connector plug having a hollow bore molded to the opposite end of the connector tube, wherein the generally straight flexible tube is adapted to be fitted at a distal end to a hearing aid device, and wherein the connector plug includes an eartip at a proximal end adapted to be inserted into a human ear.

2. The tubing system of claim 1 so sized and adapted to be fitted to a human ear, wherein the eartip is inserted into the ear canal.

3. The tubing system of claim 2, wherein the hearing aid device is a behind-the-ear (BTE) hearing aid.

4. The tubing system of claim 1, wherein each of the generally straight flexible tube and the connector tube comprise thin flexible tubing.

5. The tubing system of claim 1, wherein the generally straight flexible tube has an outer diameter in a range from about 3.0 mm to about 3.2 mm, and a wall thickness in a range from about 0.3 mm to about 0.4 mm, and a length from about 2.0 cm to about 2.5 cm.

6. The tubing system of claim 2, wherein the connector tube is a heat-treated thermoplastic material.

7. The tubing system of claim 6, wherein the heat-treated connector tube defines one or more curves.

8. The tubing system of claim 7, wherein the heat-treated connector tube defines a single curve toward the ear canal having a radius r.

9. The tubing system of claim 6, wherein the heat-treated connector tube has an outer diameter in a range from about 1.0 mm to about 1.5 mm, and a wall thickness in a range from about 0.1 mm to about 0.2 mm, and a length from about 2.0 cm to about 2.5 cm.

10. The tubing system of claim 1, wherein the eartip includes one or more annular ribs whereby a dome is frictionally fitted to the eartip.

11. The tubing system of claim 10, wherein the dome is an elastomeric open-fit dome.

12. The tubing system of claim 1, wherein the connector plug further includes a pliable stabilizer bar extending outwardly from the surface of the connector plug and unitary with the connector plug, and having a length from about 3.0 cm to about 4.0 cm.

13. A method for self-adjustment and fitting of a tubing system for a hearing aid by an individual user for an ear of the user, comprising the steps of:
(a) providing a tubing system for a hearing aid comprising:
a generally straight flexible thermoplastic tube adapted for cutting by the user,
a connector tube molded to one end of the generally straight flexible thermoplastic tube, and
a connector plug having a first hollow bore molded to the opposite end of the connector tube,
wherein the generally straight flexible tube is adapted to be fitted at a distal end to a hearing aid device, and wherein the connector plug includes an eartip at a proximal end adapted to be inserted into a human ear;
(b) installing a behind-the-ear (BTE) hearing aid including an ear hook having a second hollow bore for transmission of sound by hanging the ear hook over the top of and behind the ear of the user wherein the ear hook is in a substantially face-forward direction;
(c) inserting the eartip into the ear canal of the user;
(d) aligning the generally straight flexible thermoplastic tube adjacent to the ear hook in such a manner that the generally straight flexible thermoplastic tube remains generally straight;
(e) cutting the aligned generally straight flexible thermoplastic tube to provide a cut tubing having a tubing length for connecting to the ear hook; and
(f) attaching the cut tubing of the generally straight flexible thermoplastic tube to the ear hook to provide the tubing system for the hearing aid that is self-adjusted and fitted to the individual user.

14. The method of claim 13, wherein the generally straight flexible tube has an outer diameter in a range from about 3.0 mm to about 3.2 mm, and a wall thickness in a range from about 0.3 mm to about 0.4 mm, and a length from about 2.0 cm to about 2.5 cm.

15. The method of claim 13, wherein the connector tube is a heat-treated thermoplastic material.

16. The method of claim 15, wherein the heat-treated connector tube defines a single curve toward the ear canal having a radius r.

17. The method of claim 13, wherein the heat-treated connector tube has an outer diameter in a range from about 1.0 mm to about 1.5 mm, and a wall thickness in a range from about 0.1 mm to about 0.2 mm, and a length from about 2.0 cm to about 2.5 cm.

18. The method of claim 13, wherein the eartip includes one or more annular ribs whereby an elastomeric open-fit dome is frictionally fitted to the eartip.

19. The method of claim 13, wherein the connector plug further includes a pliable stabilizer bar extending outwardly from the surface of the connector plug and unitary with the connector plug, and having a length from about 3.0 cm to about 4.0 cm.

20. The method of claim 19, further comprising the steps of:
(g) optionally cutting the pliable stabilizer bar, and
(h) fitting the pliable stabilizer bar within the ear of the user in such a manner that the eartip is tensioned toward and held within the ear canal of the user.
